(19) United States
(12) Patent Application Publication
(10) Pub. No.: US 2014/0119047 A1
(43) Pub. Date: May 1, 2014

(54) ELECTRONIC INCENSE STICK

(71) Applicant: HON HAI PRECISION INDUSTRY CO., LTD., New Taipei (TW)

(72) Inventor: BING-HENG LEE, New Taipei (TW)

(73) Assignee: HON HAI PRECISION INDUSTRY CO., LTD., New Taipei (TW)

(21) Appl. No.: 13/864,254

(22) Filed: Apr. 17, 2013

(30) Foreign Application Priority Data
Oct. 30, 2012 (TW) 101140209

(51) Int. Cl. F21V 33/00; F21V 8/00

(52) U.S. Cl. CPC F21V 33/0028; G02B 6/0001
USPC 362/562; 362/565

(57) ABSTRACT

An electronic incense stick includes a light guide bar, a hollow tube accommodating the light guide bar, and a light source. The light guide bar includes a first end and a second end away from the first end. The light guide bar includes an incense head positioned at the second end. The incense head includes a first portion away from the first end and a second portion connecting with the first portion. A roughness of the first portion is smaller than a roughness of the second portion. The light source is positioned on the first end of the light guide bar.

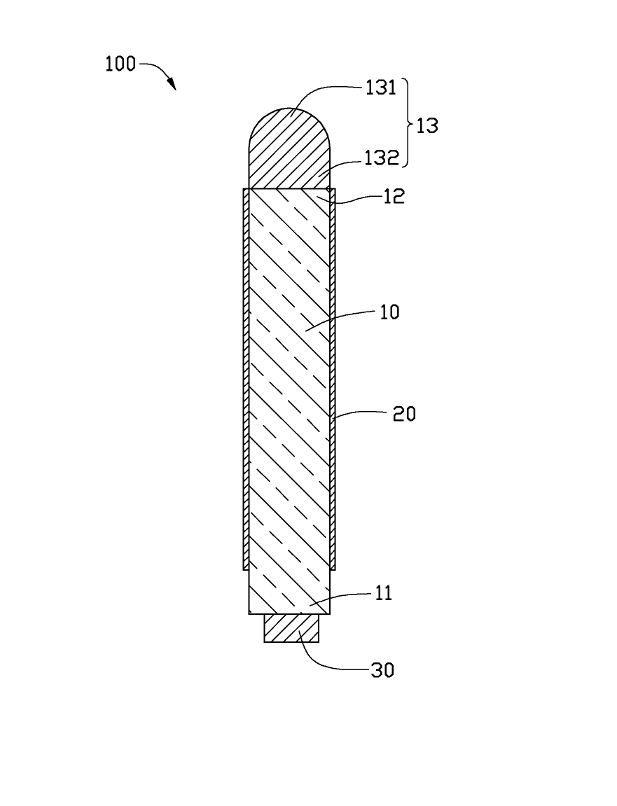

### BACKGROUND

1. Technical Field

The present disclosure relates to an electronic incense stick.

2. Description of Related Art

Electronic incense sticks typically includes a transparent tube having an opened end and a bulb portion at an opposite end of the tube, non-transparent coatings on an outer surface of the tube to simulate an incense coating and a bone part of traditional incense sticks, and a light emitting diode (LED) positioned at the opened end. The LED emits light, which is directed to the bulb portion via multiple internal reflections on an inner surface of the tube. Thus, the electronic incense stick appears burning-like. However, the electronic incense sticks are not vivid in morphology in comparison to the traditional incense sticks.

Therefore, it is desirable to provide an electronic incense stick which can overcome the above-mentioned limitations.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

The figure is a cross-sectional schematic view of an electronic incense stick according to an embodiment.

### DETAILED DESCRIPTION

The figure shows an electronic incense stick 100, according to an embodiment. The electronic incense stick 100 includes a light guide bar 10, a hollow tube 20 for accommodating the light guide bar 10, and a light source 30.

The light guide bar 10 includes a first end 11 and a second end 12 away from the first end 11. An incense head 13 is positioned at the second end 12 of the light guide bar 10. The incense head 13 includes a first portion 131 away from the first end 11, and a second portion 132 connecting with the first portion 131. The second portion 132 contacts with the first end 11. A roughness of the first portion 131 is smaller than the roughness of the second region 132. In the embodiment, the first portion 131 is the polished region by fine grinding method, the second region 132 is the atomization region by coarse grinding method. Therefore, the first portion 131 is capable of simulating burning-like of the traditional incense sticks, and the second portion 132 is capable of simulating incense ashes of the traditional incense sticks, when the electronic incense stick 100 is used. In particular, the incense head 13 is bullet-shaped by grinding method.

The hollow tube 20 is formed on the outer surface of the light guide bar 10 for accommodating the light guide bar 10. A length of the hollow tube 20 is smaller than a length of the light guide bar 10. As such, the first end 11 and the second end 12 are exposed out of the hollow tube 20. In the embodiment, the hollow tube 20 is configured to simulate incense coating of traditional incense sticks. Accordingly, the hollow tube 20 can have a yellow or red color. In particular, the hollow tube 20 has a thermoplastic property. In assembly, the hollow tube 20 is coiled around the light guide bar 10, then heating the hollow tube 20 through a hot air source to make the hollow tube 20 closely contact with the light guide bar 10.

A portion of an end of the hollow tube 20 which is close to the incense head 13 is black along an axial length of 2 mm to simulate bottom ashes of traditional incense sticks, after combustion.

The light source 30 is positioned on the first end 11 of the light guide bar 10. The light source 30 can be a lamp or a light emitting diode and configured for emitting light.

In use, the light source 30 emits a highly collimated light beam into the light guide bar 10, which transmits to the incense head 13 along a central axis of the light guide bar 10. Then, the light beam is diffused by the incense head 13 to light up the whole light guide bar 10. As such, the electronic incense stick 100 appears burning-like.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. An electronic incense stick comprising:
a light guide bar comprising a first end and a second end away from the first end, the light guide bar comprising an incense head positioned at the second end, the incense head comprising a first portion away from the first end and a second portion connecting with the first portion and the second end, a roughness of the first portion being smaller than a roughness of the second portion;
a hollow tube accommodating the light guide bar; and
a light source positioned on the first end of the light guide bar.

2. The electronic incense stick of claim 1, wherein the first portion is a polished region by fine grinding method, and the second region is an atomization region by coarse grinding method.

3. The electronic incense stick of claim 1, wherein the incense head is bullet-shaped.

4. The electronic incense stick of claim 1, wherein a length of the hollow tube is smaller than a length of the light guide bar, and the first end and the second end are exposed out of the hollow tube.

5. The electronic incense stick of claim 1, wherein the hollow tube has a yellow or red color.

6. The electronic incense stick of claim 1, wherein the hollow tube has a thermoplastic property, and the hollow tube closely contacts with the light guide bar through a hot air source.

7. The electronic incense stick of claim 1, wherein a portion of an end of the hollow tube which is close to the incense head is black.

8. The electronic incense stick of claim 1, wherein the light source can be a lamp or a light emitting diode.
